(19) United States
(12) Patent Application Publication
(10) Pub. No.: US 2018/0267516 A1
(43) Pub. Date: Sep. 20, 2018

(54) Automated Batch Data Analysis

(71) Applicant: Lonza Limited, Visp (CH)

(72) Inventors: Leslie FISTER, Portsmouth, NH (US); Michael GOETTER, Mount Laurel, NJ (US)

(21) Appl. No.: 15/923,799

(22) Filed: Mar. 16, 2018

Related U.S. Application Data
(60) Provisional application No. 62/472,990, filed on Mar. 17, 2017.

(51) Int. Cl. G05B 19/418

(52) U.S. Cl. CPC G05B 19/4188; G05B 2219/31372

(57) ABSTRACT

A system for automated batch data analysis is provided. The system for automated batch data analysis includes, for example, at least one system component and a database. The system also includes at least one computing device for executing stored programmable instructions to: acquire data associated with the system component, determine which data from the received data are identified for extraction based at least in part on a tag, and extract the tagged data based on the determination.

### CROSS REFERENCE TO RELATED APPLICATIONS

This application claims priority to and the benefit of U.S. Provisional Application No. 62/472,990, filed Mar. 17, 2017, which is expressly incorporated herein by reference in its entirety.

U.S. Provisional Application No. 62/246,478, filed Oct. 26, 2015, U.S. Provisional Application No. 62/299,930, filed Feb. 25, 2016, and PCT International Application No. PCT/EP2016/075869, filed Oct. 26, 2016 are also expressly incorporated herein by reference in their entirety.

### BACKGROUND ART

The present invention relates to a system and method for automated batch data analysis, for example, automatically identifying, extracting, and outputting certain information in relatable form along with context corresponding to the extracted information for analysis. The automated batch data analysis, for instance, may be performed in connection with pharmaceutical production.

Data processing involves collecting and processing volumes of data over a given period of time, including high volumes of data. For instance, in the life sciences industry, manufacturing execution systems (MES) may be employed to help manufacturers ensure bio-product quality and safety. This can be done by using the batch records to identify the conditions under which a product is being or was manufactured and/or verifying that these conditions are in accordance with various process requirements. An MES may be integrated with one or more digital control systems to collect manually entered data by operators, data from enterprise planning systems, data captured from plant-floor control systems, etc. while also verifying that the data is within expected ranges (and alerting operators if any abnormal situations arise). The consolidated data may then be entered into one or more batch record documents, which may be saved in a MES database. In this configuration, if an operator desires to retrieve and analyze a set of parameters captured from an external analytics system, the specific information related to the parameter must be “pulled out” from the vast amounts of information in the MES database.

In the aforementioned “pull” procedure, one of the disadvantages is that data or related information may be scattered across numerous tables in the MES database, and the ability to obtain certain kinds of information—especially on the fly—from the data, such as the above set of parameters, may be extremely difficult due to various limitations, such as system bandwidth limitations, processing that is resource-intensive in nature, and the overall quantity and disorganization of the information. Moreover, databases storing the batch records are typically built with the intent of executing information, and typically are not built to extract information in any relatable or useable form or any context associated with the information.

### SUMMARY OF THE INVENTION

In accordance with one or more aspects of the disclosure, the invention is directed to systems and methods for automated batch data analysis. Certain information in the data may be tagged as information of interest. In at least that regard, the tagged information may be extracted or “pushed out” to a separate database for further analysis. The tagging procedure may be implemented during the building of the set of instructions for performing a particular task associated with an external analytics system associated with the collected data, for example, pH values of a titration process in a bioreactor tank. Moreover, the pushed out information may also be provided with contextual data or information that may give the user and/or operator some form of context with respect to the information that is pushed out.

### BRIEF DESCRIPTION OF THE DRAWINGS

FIGS. 1 and 2 illustrate example systems in accordance with one or more aspects of the invention.

FIG. 3 illustrates another system in accordance with one or more aspects of the invention.

FIG. 4 illustrates an example flow diagram of a recipe in accordance with one or more aspects of the invention.

FIG. 5 illustrates an example database table in accordance with one or more aspects of the invention.

FIG. 6 illustrates an example flow chart in accordance with one or more aspects of the invention.

### DETAILED DESCRIPTION OF EMBODIMENTS OF THE INVENTION

The invention is directed to automated batch data analysis. In one example, a computing device of an MES may automatically identify, extract, and output one or more parameters associated with an MES recipe (e.g., a combination or a set of instructions for executing certain tasks associated with an external analytics system), for instance, to a database table, output file, etc., for further analysis. The MES, in one aspect, may be used to execute batch processes that include the implementation of one or more bioreactors and/or related equipment for producing biological products. The one or more parameters that are output, for example, may be parameters related to process conditions inside the tank that are of interest for subsequent analysis, such as the pH values of the bioreactor medium in the tank prior to, during, and after titration. In addition to the one or more parameters, further information or context related to the one or more parameters may also be provided, such as bioreactor tank identification information, plant location information, the exact times the pH measurements were taken, etc.

In accordance with examples of the disclosure, the one or more parameters to be extracted and output may be “tagged” prior to executing the MES recipe. As will be further discussed below, for example, when building the computer instruction set for carrying out the MES recipe, such as the above described titration process in the bioreactor tank, every parameter that is of interest for each of the instructions that make up the computer instruction set are tagged so that when a particular instruction is executed (e.g., titrate), the tagged parameter (e.g., pH of the bioreactor medium at the time of titration) is identified, extracted, and may be “pushed out” to a separate database, which may be further processed and analyzed.

As such, certain information in the data that is of interest is “tagged” prior to the collection of the information in the data so that the “tagged” information is automatically identified and extracted (e.g., “pushed”) to a separate database for further analysis. In at least that regard, one of the numerous advantages of the present disclosure is avoiding the slow, resource-intensive processing of information associated with the above-described “pull” procedure in conventional batch data processing methods. This advantage is gained, for instance, the extracted information (based on the tags) may be stored in local memory of a computing device, as opposed to executing database calls to retrieve the information across numerous tables in the MES database. Another advantage of the disclosure is that the tagged data and/or information is pushed out to a messaging queue or other data repository while the MES recipe is running, and thus, the extraction of data does not affect the recipe process.

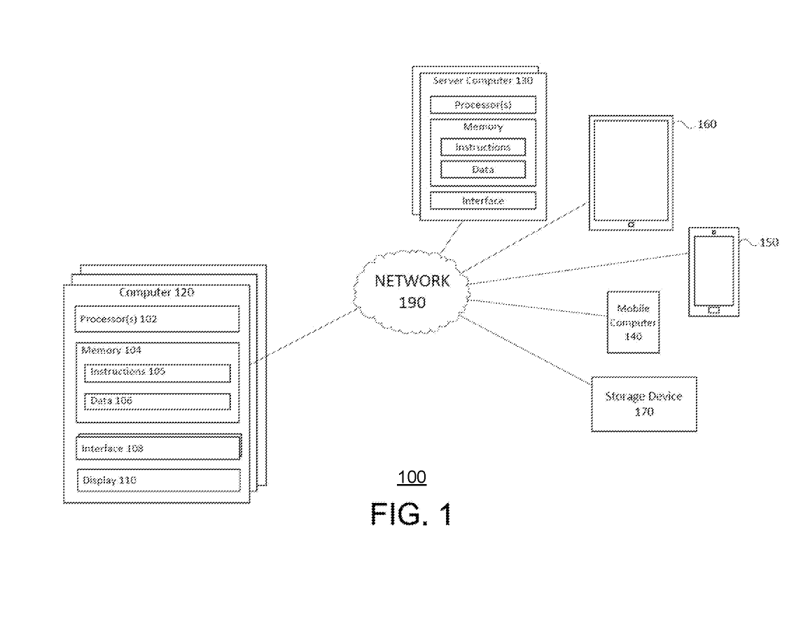

FIG. 1 illustrates an example system 100 in accordance with one or more aspects of the invention. The system 100 may include one or more computing devices, e.g., computer 120, server computer 130, mobile computer 140, smartphone device 150, tablet computer 160, and storage device 170 connected to a network 190. For example, the computer 120 may be a desktop computer, which is intended for use by one or more users. The computer 120 includes various components associated with a desktop computer, such as one or more processors 102, memory 104, e.g., permanent or flash memory (which includes instructions 105 and data 106), one or more interfaces 108, and a display 110. In a further example, similar to the computer 120, the server computer 130 may include at least one processor, memory which also includes instructions and data, one or more interfaces, and/or a display (not shown). Moreover, the mobile computing device 140 may be a laptop (or any type of computer that is portable or mobile, such as an Ultrabook) and also include components similar to the computer 120 and/or server computer 130. The computer 120 may be configured to communicate with the server computer 130, the mobile computer 140, the smartphone device 150, the tablet computer 160 and/or the storage device 170 via the network 190. As shown in FIG. 1, the cascaded blocks associated with a particular component illustrate that more than one of those components may exist, which is only an example, and it may be understood that different components can be cascaded and that there may be numerous variations thereof.

The computer 120 may include a processor 102 (e.g., controller, which will be further discussed below), which instructs the various components of computer 120 to perform tasks based on the processing of certain information, such as instructions 105 and/or data 106 stored in the memory 104. For example, the processor 102 may be hardware that can be configured to perform one or more operations, e.g., adding, subtracting, multiplying, comparing, jumping from one program to another program, operating input and output, etc., and may be any standard processor, such as a central processing unit (CPU), or may be a dedicated processor, such as an application-specific integrated circuit (ASIC) or a field programmable gate array (FPGA) or an industrial process controller. Moreover, the processor 102 may have any suitable configuration and/or configuration of circuitry that processes information and/or instructs the components of computer 120. While one processor block is shown in FIG. 1, it may be understood that the computer 120 may also include multiple processors to individually or collectively perform tasks, as described above. In one or more embodiments, the computer 120 may be an industrial controller.

Memory 104, whether permanent or flash, may be any type of hardware configured to store information accessible by the processor 102, such as instructions 105 and data 106, which can be executed, retrieved, manipulated, and/or stored by the processor 102. It may be physically contained in the computer 120 or coupled to the computer 120. For example, memory 104 may be ROM, RAM, CD-ROM, hard drive, write-capable, read-only, etc.

Moreover, the instructions 105 stored in memory 104 may include any set of instructions that can be executed directly or indirectly by the processor 102. For example, the instructions 105 may be one or more “steps” associated with software that can be executed by the processor 102. The instructions 105 may be also transferred onto memory 104 in various way, e.g., from server computer 130 and/or storage device 170 via network 190. In addition, the data 106 stored in memory 104 may be retrieved, stored or modified by the processor 102, for example, in accordance with the instructions 105. In one aspect, the data 106 may be stored as a collection of data. For instance, although the invention is not limited by any particular data structure, the data 106 may be stored in registers, in a database as a table having multiple fields and records, such as an XML. The data 106 may be formatted in any computer readable format such as, but not limited to, ASCII, Extended Binary-Coded Decimal Interchange Code (EBCDIC), binary, Objectivity, SQL or other suitable database formats, etc. The data 106 may also be any information sufficient to identify the relevant data, such as text, codes, pointers, information used by one or more functions to calculate the data, etc. Similar to the instructions 105, the data 106 may also be transferred onto memory 104 from various components via network 190.

Interface 108 may be a particular device (such as a field-mounted instrument, processor-to-processor communication, keyboard, mouse, touch sensitive screen, camera, microphone, etc.), a connection or port or wirelessly that allows the reception of information and data, such as interactions from a user or information/data from various components via network 190. For instance, the interface 122 may include one or more input/output ports. The input/output ports may include any suitable type of data port, such as a digital control bus (Foundation™, ProfitbusDP™, DeviceNet™, Modbus IEEE RS-485, Modbus/IP, Serial IEEE RS-232, universal serial bus (USB) drive, zip drive, card reader, CD drive, DVD drive, etc.

The display 110 may be any suitable type of device capable of communicating data to a user. For example, the display 110 may be a liquid-crystal display (LCD) screen, a light emitting diode (LED) screen, a plasma screen, etc. The display 110 may provide to the user various types of information, such as visual representations of the software that can be executed by the computer 120 and various data, and the like, associated therewith.

According to one aspect, a user may input information and/or data using the interface 108. The interface 108 may be a graphical user interface (GUI) that is displayed to the user/operator on the display 110. By way of example, the GUI may be an operator interface (01) that displays processing units and data to a user/operator.

The server computer 130 may be rack mounted on a network equipment rack and/or located in a data center. In some examples, via the network 190, the server computer 130 may serve various requests associated with the programs executed on the computer 120, mobile computer 140, the smartphone device 150, the tablet computer 160, and/or the storage device 170. In further examples, the server computer 130 may be part of a plurality of server computers that support a back-end system (which may be “invisible” to users).

Mobile or portable computing devices, such as the mobile computer 140, the smartphone device 150, and tablet computer 160, may include similar components and functions to the computer 120 and/or server computer 130, e.g., one or more processors, memory, input/output capabilities, display, etc. and, by common Thin Client and Remote Desktop protocols, access display 110 and interface 108 present on the computer 120.

For example, the mobile computer 140 may be any type of device that is mobile or portable with computing capability and connectivity to a network. For example, the mobile computer 140 may be a laptop, an Ultrabook, smartphone, PDA, tablet computer, a wearable computing device, etc. The mobile computer 140 may also have one or more processors, memory, user interfaces, wired or wireless network connection hardware, and other types of components associated with a mobile computing device. Thus, the mobile computer 140 may be able to connect to network 190 via a wired or a wireless connection and communicate with other components connected to the network 190, such as server computer 130, storage device 170, etc.

The smartphone device 150 may be a mobile cellular phone with computing capability and network connectivity. For example, the smartphone 150 may include one or more processors, memory, one or more user interfaces, such as a QWERTY keypad, voice recognition, a camera, image sensors, a global positioning system (GPS), accelerator, temperature sensors, etc. Similar to the computer 120 and the server computer 130, the smartphone device 150 may be configured to execute computer instructions, applications, programs, and any set of instructions and data. Moreover, the tablet computer 160 may also include one or more processors (configured to execute computer instructions and/or applications), memory, one or more interfaces, a touchscreen display, sensors, microphone, camera, speakers, networking hardware (configured to connect to a network, such as network 190, via a wired or wireless connection), etc.

The storage device 170 may be configured to store a large quantity of data and may also be configured to transfer such data when requested or accessed by other components of network 190. For example, the storage device 170 may be a collection of storage components, such as ROM, RAM, hard-drives, solid-state drives, removable drives, network storage, virtual memory, multi-leveled cache, registers, CD, DVD, etc. In addition, the storage device 170 may be configured so other components of network 190, such as the computer 120 and/or server computer 130, can access and provide data to other components connected to the network 190. In some embodiments, a device such as the storage device 170 may be considered the MES database for storage of data related to batch processes and/or batch products.

The network 190 may be any suitable type of network, wired or wireless, configured to facilitate the transmission of data, instructions, etc. between one or more components of the network. For example, the network 190 may be a local area network (LAN) (e.g., Ethernet or other IEEE 802.03 LAN technologies), Wi-Fi (e.g., IEEE 802.11 standards), wide area network (WAN), virtual private network (VPN), global area network (GAN), or any combinations thereof. In this regard, the computer 120, server computer 130, mobile computer 140, smartphone device 150, and/or tablet computer 160 may connect to and communicate with one another via the network 190.

While the computer 120 may be a desktop computer in the above-described examples, computer 120 is not limited to just desktop computers, and any of the computers illustrated in FIG. 1 may be any device capable of processing data and/or instructions and transmitting and/or receiving data. Moreover, it will be understood by those of ordinary skill in the art that those components may actually include multiple processors, memories, instructions, data or displays that may or may not be stored within the same physical housing. For example, some or all of the instructions 105 and data 106 may be stored on removable media, or may be stored in a location physically remote from, yet still accessible by, the processor 102. And although the various components of FIG. 1 are connected to the network 190, it may be understood that the components may also be connected to each other, in any suitable combination.

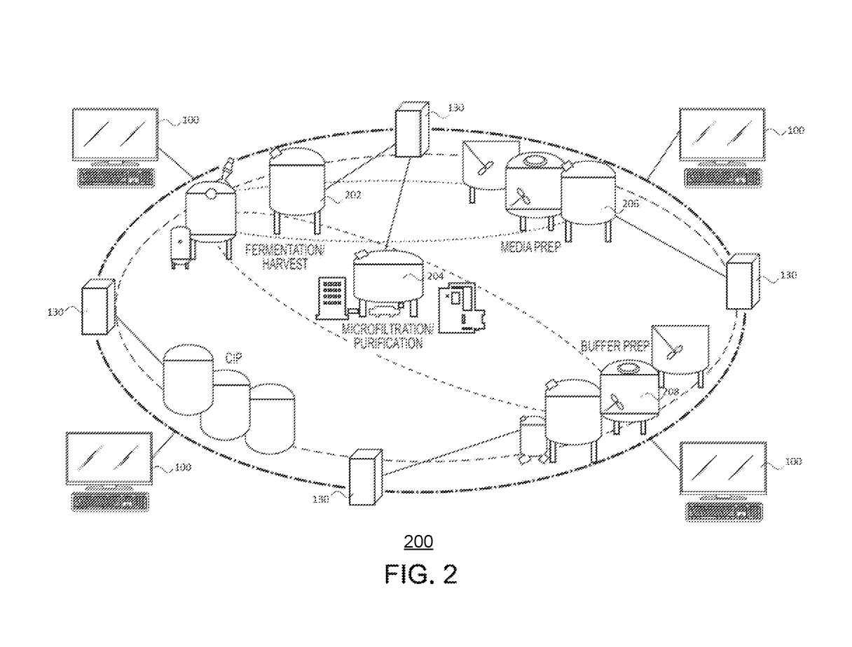

FIG. 2 illustrates another example system 200 in accordance with aspects of the invention. In this example, the system 200 represents a manufacturing execution system (MES), and the various components depicted in FIG. 1, may be configured in such a manner to facilitate the control of the bioreactors and related equipment for the production of biological products, such as equipment 202 for fermentation and/or harvest, equipment 204 for microfiltration and purification (e.g., chromatography skid), equipment 206 for media preparation, such as Clean In Place (CIP) systems and System In Place (SIP) systems, equipment 208 for buffer preparation, and various field devices (e.g., sensors with transmitters, scales, switches, pumps, control valves, discrete valves, pumps with fixed-speed starters or variable frequency drives, agitators with variable frequency drives, discrete valves with limit switches). One or more computers, such as computer 120 of FIG. 1, may be dispersed throughout the system 200 and each computer may be dedicated to certain control and/or portions of the depicted system. Similarly, server computers, such as server computer 130 of FIG. 1, may also be physical or virtual and dispersed throughout the system 200 and dedicated to certain portions of the system to facilitate the communication of data and instructions. Moreover, it may be understood that the various system components facilitated by the MES may be for one or more chemical processes (e.g., components such as a chemical reactor, etc.) in addition to and/or alternative to components used for small molecule processes, such as the components depicted in FIG. 1.

While FIG. 2 illustrates a stand-alone MES, according to another embodiment of the invention, an MES may be implemented with a control system to operate as one system. By way of example, the system 200 of FIG. 2, which is an MES system, may be combined with a plant wide control system (PWCS) to operate as one system.

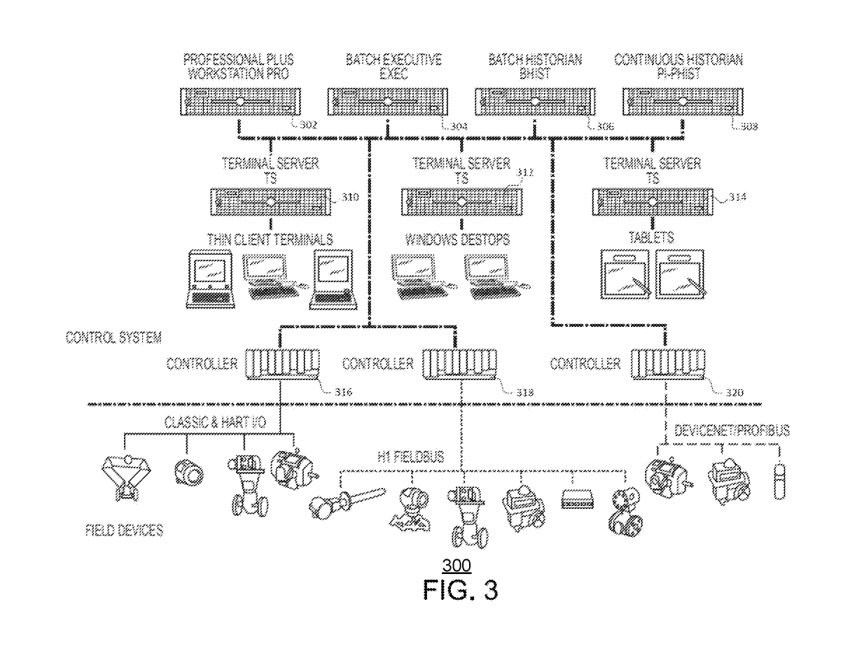

FIG. 3 illustrates a system 300, for example, incorporating an MES (e.g., system 200) illustrated in FIG. 2 and a PWCS in accordance with one or more aspects of the invention. As shown in FIG. 3, the Professional Plus Workstation (PRO) 302 may be the database for the system 300, the Batch Executive (EXEC) 304 stores, for instance, “recipe” information (which will be further discussed below) and may control batch processing, the Batch Historian (BHIST) 306 records and stores batch-related data from the system 300, the Continuous Historian (PI-PHIST) 308 records and stores continuous plant data from the system 300, each of the Terminal Servers (TS) 310, 312, and 314 may be a host for remote access sessions for thin client terminals, such as desktop computers and tablet computers, and each of the controllers 316, 318, and 320 is a system device that may execute and run algorithms and/or set of executable instructions used to control the various equipment and functionalities. Any one of the illustrated components in FIG. 3 may be (or correspond to) one or more of the computer 120, server computer 130, mobile computer 140, smartphone device 150, tablet computer 160, and the storage device 170. In embodiments, the controllers 316, 318, and 320, which may be hardware, implement one or more control modules, which may be software, to control one or more control loops, which control the various field devices of the system 300 illustrated in FIG. 3, such as various sensors, probes, actuators, pumps, agitators, monitors, etc., via the control modules.

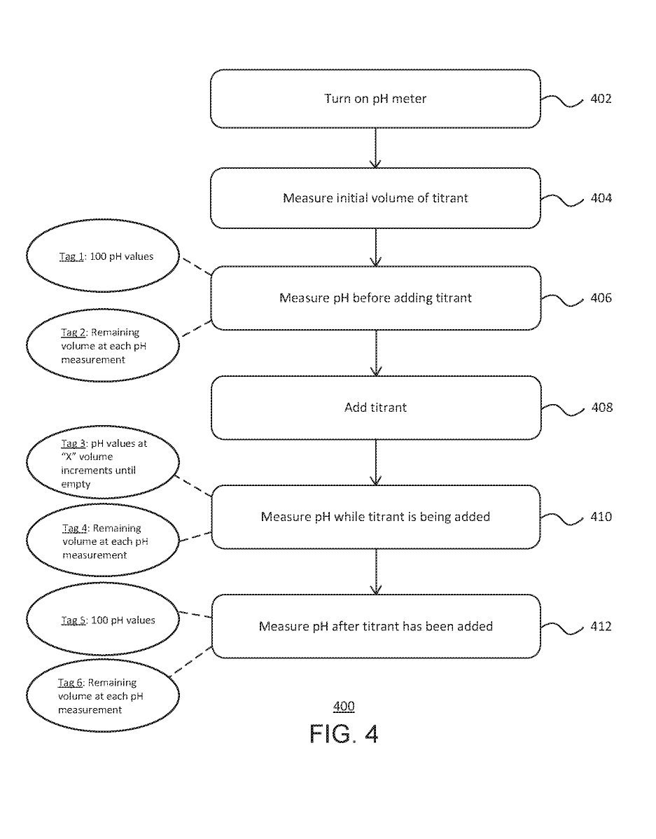

FIG. 4 illustrates a flow diagram 400 of a titration recipe and parameter “tagging” in accordance with one or more aspects of the invention. By way of example, a “recipe” may be a combination or a set of instructions for executing certain tasks associated with an external analytics system. And each instruction of the instruction set can execute a step of a particular process. In embodiments, recipes may be uniquely built by users and/or operators from scratch for different types of processes and tasks. Alternatively, they can also be readily available or pre-programmed recipes. As will be described below, certain parameters may be tagged for extraction as the instructions of the recipe are executed. The tagging process may also be implemented from scratch by the users and/or operators. In FIG. 4, a recipe for performing titration for a bioreactor tank is shown. For instance, the bioreactor tank may be the tank for media preparation or the tank for buffer preparation in the PWCS shown in FIG. 2. Moreover, the titration recipe may be stored the Batch Executive (EXEC) 304, as described above in FIG. 3, and executed by one or more terminals, such as computer 120.

As illustrated in FIG. 4, the titration recipe may include a set of at least six different instructions. When the titration recipe is executed by one or more computing devices, instruction 402 allows a pH meter or sensor in the tank to be turned on (if the pH meter is not already turned on). Then, instruction 404 allows the measurement of the initial volume of titrant being used. At instruction 406, one or more pH values may be measured before the titrant is added to the medium in the bioreactor tank. At instruction 408, the titrant is added to the medium in the bioreactor tank. As titrant is added, at instruction 410, one or more pH values may be continuously measured. For example, a pH value may be incrementally measured at every “X” volume measurement of titrant that is added into the medium until all of the titrant has been added. Subsequently, instruction 412 allows the measurement of one or more pH values after the addition of the titrant into the medium. As described above and as will be understood by persons of ordinary skill in the art, the user and/or operator may build the titration recipe differently than the above described recipe, e.g., as simple or complex as the user and/or operator desires.

FIG. 4 also shows an example of parameter “tagging” in accordance with aspects of the invention. By way of example, pH values of the medium in the bioreactor tank prior to, during, and after the titration process may be of interest for further analysis. In at least that regard, the users and/or operators that build the titration recipe may also implement into the one or more individual instructions “tags” for any parameters of interest.

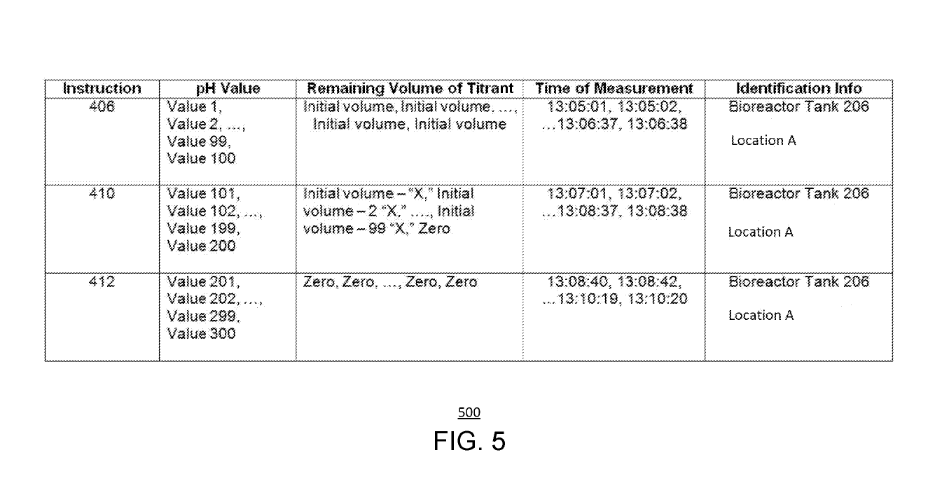

In FIG. 4, for instance, there may be six different tags to extract various parameters associated with the titration process. Tag 1 may be implemented with instruction 406 and configured to extract a hundred consecutively measured pH values before titrant is added to the medium. Similarly, Tag 2 may be implemented with instruction 406, but may be configured to extract the remaining volume measurements of titrant at each of the hundred pH value measurements associated with Tag 1. As will be described below with respect to FIG. 5, the remaining volume of titrant should all be the same at each pH measurement since the titrant has not yet been added to the medium (e.g., the “add titrant” instruction has not yet been executed). Tag 3 may be implemented with instruction 410 and configured to extract measured pH values at “X” volume increments (e.g., 2 mL) of the titrant until all of the titrant has been added into the medium. For example, there may be a hundred increments, which may equate to a hundred pH readings. Tag 4 may also be implemented with instruction 410 and configured to extract the remaining volume measurements of the titrant at every pH reading. For example, the remaining volume at each pH measurement should continually decrease as more and more titrant is added to the medium. Tag 5, similar to Tag 1, extracts a hundred consecutively measured pH values after all of the titrant has been added to the medium in the bioreactor tank, but associated with instruction 412. Also associated with instruction 412 is Tag 6 configured to extract the remaining volume measurements of the titrant, all of which should be zero or approximately zero. It may be understood by those of ordinary skill in the art that not all of the above described tags 1-6 are necessary and that one or more of them may be selected in different combinations in additional embodiments.

Although FIG. 4 illustrates a titration recipe associated with a bioreactor tank, parameter tagging may be applied to different types of recipes associated with all sorts of components of a system, such as instructions for controlling sensors with transmitters, scales, switches, pumps, control valves, discrete valves, pumps with fixed-speed starters or variable frequency drives, agitators with variable frequency drives, discrete valves with limit switches, etc. Moreover, in a further example, data acquired for parameter tagging may not originate from the system component itself, such as the bioreactor tank, transmitters, scales, switches, etc., as set forth above, but there may be instances when an operator may perform a manual activity and enter the data into the system. For instance, data and/or results may originate from a benchtop test where the operator selects a result of either “pass” or “fail,” which may constitute as the tagging or identified for tagging in accordance with aspect(s) of the present invention.

FIG. 5 illustrates an example database table 500 in accordance with one or more aspects of the present invention. By way of example, the database table 500 may include all of the extracted or “pushed” parameters that have been previously tagged for extraction or “pushing out,” which may be output to the database table 500 during and/or after the execution of the titration recipe shown in FIG. 4. The local memory of the one or more computing devices, as illustrated in FIGS. 2 and/or 3 for instance, may store the database table 500. It may be understood that in embodiments, the database table 500 may also reside in a separate database for further data retrieval and analysis. In further embodiments, the parameters may be pushed out to a messaging queue for continued processing, which may then be collected and packaged into a particular format (e.g., database table 500, xml format, etc.). The parameters and the metadata associated with the parameters, as will be discussed further discussed below, automatically can be formatted in any fashion. For instance, FIG. 5 illustrates a table, but the extracted information may be organized and/or summarized in any suitable format. The parameters and/or the metadata, in accordance with one or more aspects of the disclosure, may be selectable (e.g., in real-time as the recipe is still being executed, after the aggregation of the data), as presented in the above-described format.

As shown in FIG. 5, the database table 500 may have three rows, each row containing the parameters corresponding to their respective instructions (e.g., instruction 406, instruction 410, instruction 412, etc.). Moreover, the database table may also include five columns: the first column specifies the specific instruction in the titration recipe illustrated in FIG. 4, the second column contains the extracted pH parameters for each of the instructions, the third column indicates the remaining volume measurement of the titrant for each of the instructions, the fourth column specifies the exact time the measurements were taken for each of the instructions, and the fifth column shows any relevant information, context, metadata, etc. associated with the measurements for each of the instructions, such as the identification information associated with the bioreactor tank, what type of system the tank is associated with (MES and/or combination system of MES and PWCS), where the tank is geographically located, etc. As described above, a user may be able to select any information in the database table 500, such as the “bioreactor tank 206” text, in which the computing device may display that the tank is currently part of the MES system 200, as illustrated in FIG. 2, and/or the user may also be able to select the actual parameters. As such, by selecting the extracted information, the user may be presented with relatable and important information (such as operator comments, notes, etc.) helpful for further analysis of the information.

Referring back to FIG. 4, when the pH and volume measurement parameters are extracted or pushed out by way of Tags 3 and 4 when instruction 410 is executed, the middle row (corresponding to instruction 410) may be populated with the same. As described above, for example, there may be a total of a hundred “X” volume measurements in the initial volume of the titrant being used. In other words, when “X” amount of the titrant is added to the medium at a time, then it will take a total of a hundred times to add all of the titrant to the medium. At each instance of adding “X” amount, a pH reading is taken using the pH meter or sensor, e.g., pH values 101 to 200 in FIG. 5 represent these readings. In the third column of the database table 500 of FIG. 5, there are a hundred values representing the remaining volume of titrant corresponding to each pH value. For instance, the remaining volume of titrant after adding the first “X” amount will be the initial volume minus “X,” which corresponds to pH Value 101. The exact time of each measurement is also recorded. In FIG. 5, each measurement is taken every second. Moreover, contextual information may be provided, such as the identification information associated with the bioreactor tank, the name of the control system the tank is associated with, where the tank is geographically located (e.g., that the tank is located at the “Location A” facility), etc., as described above. Other various parameters may similarly be populated in the database table 500, as above and as shown in FIG. 5.

As described above, information in the database table 500, along with other numerous types of information that may be extracted or pushed out by way of tagging in other recipes, may be stored in a separate database. In at least that regard, the information is easily accessible by users and/or operators for further analysis (e.g., examining and using the titration results for other types of requisite procedures in the bioreactor system, ensuring the titration results are within predetermined limits, etc.) and not scattered across different storage devices in the system database. Moreover, parameter tagging also allows for the unique identification and extraction of all parameters that are of interest with contextual information (e.g., metadata) that is useful and applicable, which is otherwise not possible in a pull procedure.

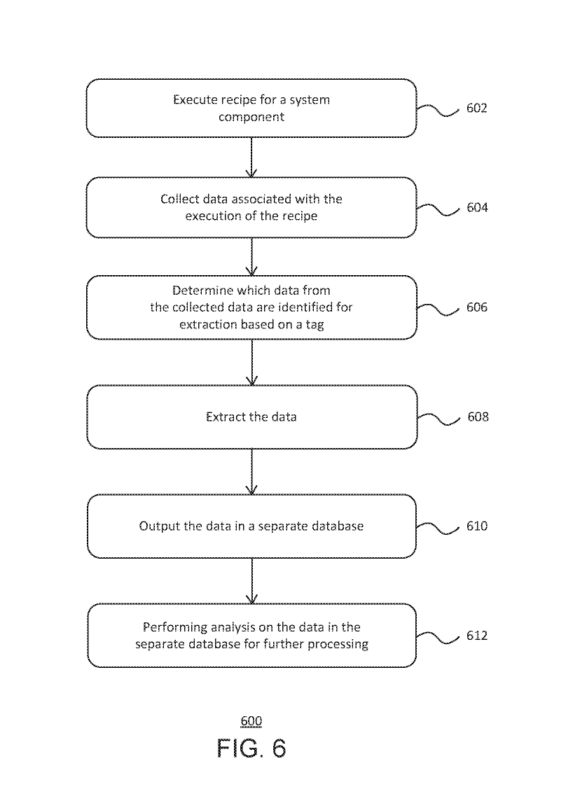

FIG. 6 illustrates a flow diagram 600 in accordance with one or more aspects of the present invention. The flow diagram 600 includes steps for identifying, extracting, and outputting certain information (e.g., parameters) in relatable form along with context corresponding to the extracted information based on the parameter tagging procedure described above. The steps of the flow diagram 600, for example, may be executed on one or more computing devices, such as computer 120 of FIG. 1.

At step 602, a computing device may execute a recipe for a component of an external analytics system, where the recipe may be the above-described titration recipe and the component may be the above-described bioreactor tank. When the recipe is executed, numerous types of information and data may be collected at step 604, of which some may be of interest. The computing device, at step 606, then determines which data from the collected data (e.g., data related to a batch process) are identified for extraction (or pushing out). The determination is based at least in part on the tagging process, which may have been already built into the recipe by a user and/or operator. Moreover, it may be understood that the determination may be made during or otherwise after the execution of the recipe.

At step 608, the data or parameters that are tagged as information of interest are subsequently extracted. Then, at step 610, the extracted data is output to a separate database and/or a messaging queue for transmittal to the separate database and/or middleware. In that regard, all the parameters, information, and/or data of interest to the user and/or operator all reside in one database, which is easily accessible at any time. As described above, the separate database may be stored in local memory of the computing device executing the recipe and/or the separate database of the system. At step 612, the aggregated data in the separate database may be accessed for further processing by any user and/or operator from any geographical location at any time. For example, an operator located in one geographical location may easily access the pH values prior to, during, and after titration of the medium in the bioreactor tank located in a differing geographical location in real-time.

The systems, devices, facilities, and/or methods described herein are suitable for use in and with culturing any desired cell line including prokaryotic and/or eukaryotic cell lines. Further, the systems, devices, facilities, and/or methods described herein allow for the production of eukaryotic cells, prokaryotic cells and/or products of the eukaryotic or prokaryotic cells, e.g., proteins, peptides, antibiotics, amino acids, nucleic acids (such as DNA or RNA), synthesized by the eukaryotic cells in a large-scale manner.

In one embodiment, the eukaryotic cells are mammalian cells. The mammalian cells can be for example human or rodent or bovine cell lines or cell strains. Examples of such cells, cell lines or cell strains include, for example, mouse myeloma (NSO)-cell lines, Chinese hamster ovary (CHO)-cell lines, HT1080, H9, HepG2, MCF7, MDBK Jurkat, NIH3T3, PC12, BHK (baby hamster kidney cell), VERO, SP2/0, YB2/0, Y0, C127, L cell, COS, e.g., COS1 and COST, QC1-3, HEK-293, VERO, PER.C6, HeLA, EB1, EB2, EB3, oncolytic or hybridoma-cell lines. Preferably the mammalian cells are CHO-cell lines. In one embodiment, the cell is a CHO cell. In one embodiment, the cell is a CHO-K1 cell, a CHO-K1 SV cell, a DG44 CHO cell, a DUXB11 CHO cell, a CHOS, a CHO GS knock-out cell, a CHO FUT8 GS knock-out cell, a CHOZN, or a CHO-derived cell. The CHO GS knock-out cell (e.g., GSKO cell) is, for example, a CHO-K1 SV GS knockout cell. The CHO FUT8 knockout cell is, for example, the Potelligent® CHOK1 SV (Lonza Biologics, Inc.).

In one embodiment, the eukaryotic cells are stem cells. The stem cells can be, for example, pluripotent stem cells, including embryonic stem cells (ESCs), adult stem cells, induced pluripotent stem cells (iPSCs), tissue specific stem cells (e.g., hematopoietic stem cells) and mesenchymal stem cells (MSCs).

In one embodiment, the eukaryotic cell is a lower eukaryotic cell. The lower eukaryotic cell can be, for example, a yeast cell. Examples of yeast cells include, for example, Pichia genus (e.g. Pichia pastoris, Pichia methanolica, Pichia kluyveri, and Pichia angusta), Komagataella genus (e.g. Komagataella pastoris, Komagataella pseudopastoris or Komagataella phaffii), Saccharomyces genus (e.g. Saccharomyces cerevisae, cerevisiae, Saccharomyces kluyveri, Saccharomyces uvarum), Kluyveromyces genus (e.g. Kluyveromyces lactis, Kluyveromyces marxianus), the Candida genus (e.g. Candida utilis, Candida cacaoi, Candida boidinii,), the Geotrichum genus (e.g. Geotrichum fermentans), Hansenula polymorpha, Yarrowia lipolytica, or Schizosaccharomyces pombe. Preferred is the species Pichia pastoris. Examples for Pichia pastoris strains are X33, GS115, KM71, KM71H; and CBS7435.

In one embodiment, the eukaryotic cell is a fungal cell. The fungal cell can be, for example, Aspergillus (such as A. niger, A. fumigatus, A. orzyae, A. nidula), Acremonium (such as A. thermophilum), Chaetomium (such as C. thermophilum), Chrysosporium (such as C. thermophile), Cordyceps (such as C. militaris), Corynascus, Ctenomyces, Fusarium (such as F. oxysporum), Glomerella (such as G. graminicola), Hypocrea (such as H. jecorina), Magnaporthe (such as M. orzyae), Myceliophthora (such as M. thermophile), Nectria (such as N. heamatococca), Neurospora (such as N. crassa), Penicillium, Sporotrichum (such as S. thermophile), Thielavia (such as T. terrestris, T. heterothallica), Trichoderma (such as T. reesei), or Verticillium (such as V. dahlia)).

In one embodiment, the eukaryotic cell is an insect cell (e.g., Sf9, Mimic™ Sf9, Sf21, High Five™ (BT1-TN-5B1-4), or BT1-Ea88 cells), an algae cell (e.g., of the genus Amphora, Bacillariophyceae, Dunaliella, Chlorella, Chlamydomonas, Cyanophyta (cyanobacteria), Nannochloropsis, Spirulina, or Ochromonas), or a plant cell (e.g., cells from monocotyledonous plants (such as maize, rice, wheat, or Setaria), or from a dicotyledonous plants (e.g., cassava, potato, soybean, tomato, tobacco, alfalfa, Physcomitrella patens or Arabidopsis).

Eukaryotic cells can also be avian cells, cell lines or cell strains, for example, EBx® cells, such as EB14, EB24, EB26, EB66, or EBv13.

In one embodiment, the prokaryotic cell is a Gram-positive cell such as Bacillus, Streptomyces Streptococcus, Staphylococcus or Lactobacillus. Examples of Bacillus include B. subtilis, B. amyloliquefaciens, B. licheniformis, B. natto, or B. megaterium. In some embodiments, the cell is B. subtilis, such as B. subtilis 3NA and B. subtilis 168. Bacillus is commercially available from the Bacillus Genetic Stock Center, Biological Sciences 556, 484 West 12^{th} Avenue, Columbus Ohio 43210-1214.

In one embodiment, the prokaryotic cell is a Gram-negative cell, such as Salmonella spp. or Escherichia coli, including e.g., TG1, TG2, W3110, DH1, DHB4, DH5a, HMS 174, HMS174 (DE3), NM533, C600, HB101, JM109, MC4100, XL1-Blue and Origami, as well as those derived from E. coli B-strains, such as BL-21 or BL21 (DE3), all of which are commercially available.

In some embodiments, the cell is a hepatocyte such as a human hepatocyte, animal hepatocyte, or a non-parenchymal cell. For example, the cell can be a plateable metabolism qualified human hepatocyte, a plateable induction qualified human hepatocyte, plateable Qualyst Transporter Certified™ human hepatocyte, suspension qualified human hepatocyte (including 10-donor and 20-donor pooled hepatocytes), human hepatic kupffer cells, human hepatic stellate cells, dog hepatocytes (including single and pooled Beagle hepatocytes), mouse hepatocytes (including CD-1 and C57BI/6 hepatocytes), rat hepatocytes (including Sprague-Dawley, Wistar Han, and Wistar hepatocytes), monkey hepatocytes (including Cynomolgus or Rhesus monkey hepatocytes), cat hepatocytes (including Domestic Shorthair hepatocytes), and rabbit hepatocytes (including New Zealand White hepatocytes). Example hepatocytes are commercially available from Triangle Research Labs, LLC, 6 Davis Drive Research Triangle Park, N.C., USA 27709.

In some embodiments, the cell is a differentiated form of any of the cells described herein. In other embodiments, the cell is a cell derived from any primary cell in culture. Suitable host cells are commercially available, for example, from culture collections such as the German Collection of Microorganisms and Cell Cultures GmbH (DSMZ) or the American Type Culture Collection (ATCC).

In some embodiments, the systems, devices, facilities, and/or methods described herein are suitable for culturing suspension cells or anchorage-dependent (adherent) cells. The systems, devices, facilities, and/or methods described herein can also be suitable for production operations configured for the production of pharmaceutical and biopharmaceutical products—such as polypeptide products, nucleic acid products (for example DNA or RNA), or cells and/or viruses such as those used in cellular and/or viral therapies. In other embodiments, the systems, devices, facilities, and/or methods described herein can be used for producing biosimilars.

In certain embodiments, the cultured cells express or produce a product, such as a recombinant therapeutic or diagnostic product. As described in more detail below, examples of products produced by cells include, but are not limited to, antibody molecules (e.g., monoclonal antibodies, bispecific antibodies), antibody mimetics (polypeptide molecules that bind specifically to antigens but that are not structurally related to antibodies such as e.g., DARPins, affibodies, adnectins, or IgNARs), fusion proteins (e.g., Fc fusion proteins, chimeric cytokines), other recombinant proteins (e.g., glycosylated proteins, enzymes, hormones), viral therapeutics (e.g., anti-cancer oncolytic viruses, viral vectors for gene therapy and viral immunotherapy), cell therapeutics (e.g., pluripotent stem cells, mesenchymal stem cells and adult stem cells), vaccines or lipid-encapsulated particles (e.g., exosomes, virus-like particles), RNA (such as e.g., siRNA) or DNA (such as e.g., plasmid DNA), antibiotics, peptides, amino acids, fatty acids or other useful biochemical intermediates or metabolites. For example, in some embodiments, molecules having a molecular weight of about 4000 daltons to greater than about 140,000 daltons can be produced. In other embodiments, these molecules can have a range of complexity and can include posttranslational modifications including glycosylation.

In embodiments, the protein is, e.g., BOTOX, Myobloc, Neurobloc, Dysport (or other serotypes of botulinum neurotoxins), alglucosidase alpha, daptomycin, YH-16, choriogonadotropin alpha, filgrastim, cetrorelix, interleukin-2, aldesleukin, teceleulin, denileukin diftitox, interferon alpha-n3 (injection), interferon alpha-nl, DL-8234, interferon, Suntory (gamma-la), interferon gamma, thymosin alpha 1, tasonermin, DigiFab, ViperaTAb, EchiTAb, CroFab, nesiritide, abatacept, alefacept, Rebif, eptoterminalfa, teriparatide (osteoporosis), calcitonin injectable (bone disease), calcitonin (nasal, osteoporosis), etanercept, hemoglobin glutamer 250 (bovine), drotrecogin alpha, collagenase, carperitide, recombinant human epidermal growth factor (topical gel, wound healing), DWP401, darbepoetin alpha, epoetin omega, epoetin beta, epoetin alpha, desirudin, lepirudin, bivalirudin, nonacog alpha, Mononine, eptacog alpha (activated), recombinant Factor VIII+VWF, Recombinate, recombinant Factor VIII, Factor VIII (recombinant), Alphnmate, octocog alpha, Factor VIII, palifermin, Indikinase, tenecteplase, alteplase, pamiteplase, reteplase, nateplase, monteplase, follitropin alpha, rFSH, hpFSH, micafungin, pegfilgrastim, lenograstim, nartograstim, sermorelin, glucagon, exenatide, pramlintide, iniglucerase, galsulfase, Leucotropin, molgramostirn, triptorelin acetate, histrelin (subcutaneous implant, Hydron), deslorelin, histrelin, nafarelin, leuprolide sustained release depot (ATRIGEL), leuprolide implant (DUROS), goserelin, Eutropin, KP-102 program, somatropin, mecasermin (growth failure), enlfavirtide, Org-33408, insulin glargine, insulin glulisine, insulin (inhaled), insulin lispro, insulin deternir, insulin (buccal, RapidMist), mecasermin rinfabate, anakinra, celmoleukin, 99 mTc-apcitide injection, myelopid, Betaseron, glatiramer acetate, Gepon, sargramostim, oprelvekin, human leukocyte-derived alpha interferons, Bilive, insulin (recombinant), recombinant human insulin, insulin aspart, mecasenin, Roferon-A, interferon-alpha 2, Alfaferone, interferon alfacon-1, interferon alpha, Avonex′ recombinant human luteinizing hormone, dornase alpha, trafermin, ziconotide, taltirelin, diboterminalfa, atosiban, becaplermin, eptifibatide, Zemaira, CTC-111, Shanvac-B, HPV vaccine (quadrivalent), octreotide, lanreotide, ancestirn, agalsidase beta, agalsidase alpha, laronidase, prezatide copper acetate (topical gel), rasburicase, ranibizumab, Actimmune, PEG-Intron, Tricomin, recombinant house dust mite allergy desensitization injection, recombinant human parathyroid hormone (PTH) 1-84 (sc, osteoporosis), epoetin delta, transgenic antithrombin III, Granditropin, Vitrase, recombinant insulin, interferon-alpha (oral lozenge), GEM-21S, vapreotide, idursulfase, omnapatrilat, recombinant serum albumin, certolizumab pegol, glucarpidase, human recombinant C1 esterase inhibitor (angioedema), lanoteplase, recombinant human growth hormone, enfuvirtide (needle-free injection, Biojector 2000), VGV-1, interferon (alpha), lucinactant, aviptadil (inhaled, pulmonary disease), icatibant, ecallantide, omiganan, Aurograb, pexigananacetate, ADI-PEG-20, LDI-200, degarelix, cintredelinbesudotox, Favld, MDX-1379, ISAtx-247, liraglutide, teriparatide (osteoporosis), tifacogin, AA4500, T4N5 liposome lotion, catumaxomab, DWP413, ART-123, Chrysalin, desmoteplase, amediplase, corifollitropinalpha, TH-9507, teduglutide, Diamyd, DWP-412, growth hormone (sustained release injection), recombinant G-CSF, insulin (inhaled, AIR), insulin (inhaled, Technosphere), insulin (inhaled, AERx), RGN-303, DiaPep277, interferon beta (hepatitis C viral infection (HCV)), interferon alpha-n3 (oral), belatacept, transdermal insulin patches, AMG-531, MBP-8298, Xerecept, opebacan, AIDSVAX, GV-1001, LymphoScan, ranpirnase, Lipoxysan, lusupultide, MP52 (beta-tricalciumphosphate carrier, bone regeneration), melanoma vaccine, sipuleucel-T, CTP-37, Insegia, vitespen, human thrombin (frozen, surgical bleeding), thrombin, TransMID, alfimeprase, Puricase, terlipressin (intravenous, hepatorenal syndrome), EUR-1008M, recombinant FGF-I (injectable, vascular disease), BDM-E, rotigaptide, ETC-216, P-113, MBI-594AN, duramycin (inhaled, cystic fibrosis), SCV-07, OPI-45, Endostatin, Angiostatin, ABT-510, Bowman Birk Inhibitor Concentrate, XMP-629, 99 mTc-Hynic-Annexin V, kahalalide F, CTCE-9908, teverelix (extended release), ozarelix, rornidepsin, BAY-504798, interleukin4, PRX-321, Pepscan, iboctadekin, rhlactoferrin, TRU-015, IL-21, ATN-161, cilengitide, Albuferon, Biphasix, IRX-2, omega interferon, PCK-3145, CAP-232, pasireotide, huN901-DMI, ovarian cancer immunotherapeutic vaccine, SB-249553, Oncovax-CL, OncoVax-P, BLP-25, CerVax-16, multi-epitope peptide melanoma vaccine (MART-1, gp100, tyrosinase), nemifitide, rAAT (inhaled), rAAT (dermatological), CGRP (inhaled, asthma), pegsunercept, thymosinbeta4, plitidepsin, GTP-200, ramoplanin, GRASPA, OBI-1, AC-100, salmon calcitonin (oral, eligen), calcitonin (oral, osteoporosis), examorelin, capromorelin, Cardeva, velafermin, 131I-TM-601, KK-220, T-10, ularitide, depelestat, hematide, Chrysalin (topical), rNAPc2, recombinant Factor V111 (PEGylated liposomal), bFGF, PEGylated recombinant staphylokinase variant, V-10153, SonoLysis Prolyse, NeuroVax, CZEN-002, islet cell neogenesis therapy, rGLP-1, BIM-51077, LY-548806, exenatide (controlled release, Medisorb), AVE-0010, GA-GCB, avorelin, ACM-9604, linaclotid eacetate, CETi-1, Hemospan, VAL (injectable), fast-acting insulin (injectable, Viadel), intranasal insulin, insulin (inhaled), insulin (oral, eligen), recombinant methionyl human leptin, pitrakinra subcutancous injection, eczema), pitrakinra (inhaled dry powder, asthma), Multikine, RG-1068, MM-093, NBI-6024, AT-001, PI-0824, Org-39141, Cpn10 (autoimmune diseases/inflammation), talactoferrin (topical), rEV-131 (ophthalmic), rEV-131 (respiratory disease), oral recombinant human insulin (diabetes), RPI-78M, oprelvekin (oral), CYT-99007 CTLA4-Ig, DTY-001, valategrast, interferon alpha-n3 (topical), IRX-3, RDP-58, Tauferon, bile salt stimulated lipase, Merispase, alaline phosphatase, EP-2104R, Melanotan-II, bremelanotide, ATL-104, recombinant human microplasmin, AX-200, SEMAX, ACV-1, Xen-2174, CJC-1008, dynorphin A, SI-6603, LAB GHRH, AER-002, BGC-728, malaria vaccine (virosomes, PeviPRO), ALTU-135, parvovirus B19 vaccine, influenza vaccine (recombinant neuraminidase), malaria/HBV vaccine, anthrax vaccine, Vacc-5q, Vacc-4x, HIV vaccine (oral), HPV vaccine, Tat Toxoid, YSPSL, CHS-13340, PTH(1-34) liposomal cream (Novasome), Ostabolin-C, PTH analog (topical, psoriasis), MBRI-93.02, MTB72F vaccine (tuberculosis), MVA-Ag85A vaccine (tuberculosis), FARA04, BA-210, recombinant plague FIV vaccine, AG-702, OxSODrol, rBetV1, Der-p1/Der-p2/Der-p7 allergen-targeting vaccine (dust mite allergy), PR1 peptide antigen (leukemia), mutant ras vaccine, HPV-16 E7 lipopeptide vaccine, labyrinthin vaccine (adenocarcinoma), CIVIL vaccine, WT1-peptide vaccine (cancer), IDD-5, CDX-110, Pentrys, Norelin, CytoFab, P-9808, VT-111, icrocaptide, telbermin (dermatological, diabetic foot ulcer), rupintrivir, reticulose, rGRF, HA, alpha-galactosidase A, ACE-011, ALTU-140, CGX-1160, angiotensin therapeutic vaccine, D-4F, ETC-642, APP-018, rhMBL, SCV-07 (oral, tuberculosis), DRF-7295, ABT-828, ErbB2-specific immunotoxin (anticancer), DT3SSIL-3, TST-10088, PRO-1762, Combotox, cholecystokinin-B/gastrin-receptor binding peptides, 111In-hEGF, AE-37, trasnizumab-DM1, Antagonist G, IL-12 (recombinant), PM-02734, IMP-321, rhIGF-BP3, BLX-883, CUV-1647 (topical), L-19 based radioimmunotherapeutics (cancer), Re-188-P-2045, AMG-386, DC/1540/KLH vaccine (cancer), VX-001, AVE-9633, AC-9301, NY-ESO-1 vaccine (peptides), NA17.A2 peptides, melanoma vaccine (pulsed antigen therapeutic), prostate cancer vaccine, CBP-501, recombinant human lactoferrin (dry eye), FX-06, AP-214, WAP-8294A (injectable), ACP-HIP, SUN-11031, peptide YY [3-36] (obesity, intranasal), FGLL, atacicept, BR3-Fc, BN-003, BA-058, human parathyroid hormone 1-34 (nasal, osteoporosis), F-18-CCR1, AT-1100 (celiac disease/diabetes), JPD-003, PTH(7-34) liposomal cream (Novasome), duramycin (ophthalmic, dry eye), CAB-2, CTCE-0214, GlycoPEGylated erythropoietin, EPO-Fc, CNTO-528, AMG-114, JR-013, Factor XIII, aminocandin, PN-951, 716155, SUN-E7001, TH-0318, BAY-73-7977, teverelix (immediate release), EP-51216, hGH (controlled release, Biosphere), OGP-I, sifuvirtide, TV4710, ALG-889, Org-41259, rhCC10, F-991, thymopentin (pulmonary diseases), r(m)CRP, hepatoselective insulin, subalin, L19-IL-2 fusion protein, elafin, NMK-150, ALTU-139, EN-122004, rhTPO, thrombopoietin receptor agonist (thrombocytopenic disorders), AL-108, AL-208, nerve growth factor antagonists (pain), SLV-317, CGX-1007, INNO-105, oral teriparatide (eligen), GEM-OS1, AC-162352, PRX-302, LFn-p24 fusion vaccine (Therapore), EP-1043, S pneumoniae pediatric vaccine, malaria vaccine, Neisseria meningitidis Group B vaccine, neonatal group B streptococcal vaccine, anthrax vaccine, HCV vaccine (gpE1+gpE2+MF-59), otitis media therapy, HCV vaccine (core antigen+ISCOMATRIX), hPTH(1-34) (transdermal, ViaDerm), 768974, SYN-101, PGN-0052, aviscumnine, BIM-23190, tuberculosis vaccine, multi-epitope tyrosinase peptide, cancer vaccine, enkastim, APC-8024, GI-5005, ACC-001, TTS-CD3, vascular-targeted TNF (solid tumors), desmopressin (buccal controlled-release), onercept, and TP-9201.

In some embodiments, the polypeptide is adalimumab (HUMIRA®), infliximab (REMICADE™), rituximab (RITUXAN™/MAB THERA™) etanercept (ENBREL™) bevacizumab (AVASTIN™), trastuzumab (HERCEPTIN™), pegrilgrastim (NEULASTA™), or any other suitable polypeptide including biosimilars and biobetters.

Other suitable polypeptides for use are those listed below and described in Table 1 of U.S. Patent Publication No. 2016/0097074:

TABLE 1

| Protein Product | Reference Listed Drug |
|---|---|
| interferon gamma-1b | Actimmune ® |
| alteplase; tissue plasminogen activator | Activase ®/Cathflo ® |
| Recombinant antihemophilic factor | Advate |
| human albumin | Albutein ® |
| Laronidase | Aldurazyme ® |
| Interferon alfa-N3, human leukocyte | Alferon N ® |
| derived | |
| human antihemophilic factor | Alphanate ® |
| virus-filtered human coagulation | AlphaNine ® SD |
| factor IX | |
| Alefacept; recombinant, dimeric fusion | Amevive ® |
| protein LFA3-Ig | |
| Bivalirudin | Angiomax ® |
| darbepoetin alfa | Aranesp ™ |
| Bevacizumab | Avastin ™ |
| interferon beta-1a; recombinant | Avonex ® |
| coagulation factor IX | BeneFix ™ |
| Interferon beta-1b | Betaseron ® |
| Tositumomab | BEXXAR ® |
| antihemophilic factor | Bioclate ™ |
| human growth hormone | BioTropin ™ |
| botulinum toxin type A | BOTOX ® |
| Alemtuzumab | Campath ® |
| acritumomab; technetium-99 labeled | CEA-Scan ® |
| alglucerase; modified form of beta- | Ceredase ® |
| glucocerebrosidase | |
| imiglucerase; recombinant form of beta- | Cerezyme ® |
| glucocerebrosidase | |
| crotalidae polyvalent immune Fab, ovine | CroFab ™ |
| digoxin immune fab [ovine] | DigiFab ™ |
| Rasburicase | Elitek ® |
| Etanercept | ENBREL ® |
| epoietin alfa | Epogen ® |
| Cetuximab | Erbitux ™ |
| algasidase beta | Fabrazyme ® |
| Urofollitropin | Fertinex ™ |
| Protein Product | Reference Listed Drug |
| follitropin beta | Follistim ™ |
| Teriparatide | FORTEO ® |
| human somatropin | GenoTropin ® |
| Glucagon | GlucaGen ® |
| follitropin alfa | Gonal-F ® |
| antihemophilic factor | Helixate ® |
| Antihemophilic Factor; Factor XIII | HEMOFIL |
| adefovir dipivoxil | Hepsera ™ |
| Trastuzumab | Herceptin ® |
| Insulin | Humalog ® |
| antihemophilic factor/von Willebrand | Humate-P ® |
| factor complex-human | |
| Somatotropin | Humatrope ® |
| Adalimumab | HUMIRA ™ |
| human insulin | Humulin ® |
| recombinant human hyaluronidase | Hylenex ™ |
| interferon alfacon-1 | Infergen ® |
| eptifibatide | Integrilin ™ |
| alpha-interferon | Intron A ® |
| Palifermin | Kepivance |
| Anakinra | Kineret ™ |
| antihemophilic factor | Kogenate ® FS |
| insulin glargine | Lantus ® |
| granulocyte macrophage colony- | Leukine ®/Leukine ® |
| stimulating factor | Liquid |
| lutropin alfa for injection | Luveris |
| OspA lipoprotein | LYMErix ™ |
| Ranibizumab | LUCENTIS ® |
| gemtuzumab ozogamicin | Mylotarg ™ |
| Galsulfase | Naglazyme ™ |
| Nesiritide | Natrecor ® |
| Pegfilgrastim | Neulasta ™ |
| Oprelvekin | Neumega ® |
| Filgrastim | Neupogen ® |
| Protein Product | Reference Listed Drug |
| Fanolesomab | NeutroSpec ™ |
| | (formerly LeuTech ®) |
| somatropin [rDNA] | Norditropin ®/ |
| | Norditropin Nordiflex ® |
| Mitoxantrone | Novantrone ® |
| insulin; zinc suspension; | Novolin L ® |
| insulin; isophane suspension | Novolin N ® |
| insulin, regular; | Novolin R ® |
| Insulin | Novolin ® |
| coagulation factor VIIa | NovoSeven ® |
| Somatropin | Nutropin ® |
| immunoglobulin intravenous | Octagam ® |
| PEG-L-asparaginase | Oncaspar ® |
| abatacept, fully human soluable | Orencia ™ |
| fusion protein | |
| muromomab-CD3 | Orthoclone OKT3 ® |
| high-molecular weight hyaluronan | Orthovisc ® |
| human chorionic gonadotropin | Ovidrel ® |
| live attenuated Bacillus Calmette-Guerin | Pacis ® |
| peginterferon alfa-2a | Pegasys ® |
| pegylated version of interferon alfa-2b | PEG-Intron ™ |
| Abarelix (injectable suspension); | Plenaxis ™ |
| gonadotropin-releasing hormone | |
| antagonist | |
| epoietin alfa | Procrit ® |
| Aldesleukin | Proleukin, IL-2 ® |
| Somatrem | Protropin ® |
| dornase alfa | Pulmozyme ® |
| Efalizumab; selective, reversible T-cell | RAPTIVA ™ |
| blocker | |
| combination of ribavirin and alpha | Rebetron ™ |
| interferon | |
| Interferon beta 1a | Rebif ® |
| antihemophilic factor | Recombinate ® rAHF/ |
| antihemophilic factor | ReFacto ® |
| Lepirudin | Refludan ® |
| Protein Product | Reference Listed Drug |
| Infliximab | REMICADE ® |
| Abciximab | ReoPro ™ |
| Reteplase | Retavase ™ |
| Rituxima | Rituxan ™ |
| interferon alfa-2^{a} | Roferon-A ® |
| Somatropin | Saizen ® |
| synthetic porcine secretin | SecreFlo ™ |
| Basiliximab | Simulect ® |
| Eculizumab | SOURIS (R) |
| Pegvisomant | SOMAVERT ® |
| Palivizumab; recombinantly produced, | Synagis ™ |
| humanized mAb | |
| thyrotropin alfa | Thyrogen ® |
| Tenecteplase | TNKase ™ |
| Natalizumab | TYSABRI ® |
| human immune globulin intravenous | Venoglobulin-S ® |
| 5% and 10% solutions | |
| interferon alfa-n1, lymphoblastoid | Wellferon ® |
| drotrecogin alfa | Xigris ™ |
| Omalizumab; recombinant DNA-derived | Xolair ® |
| humanized monoclonal | |
| antibody targeting immunoglobulin-E | |
| Daclizumab | Zenapax ® |
| ibritumomab tiuxetan | Zevalin ™ |
| Somatotropin | Zorbtive ™ (Serostim ®) |

In other embodiments, the polypeptide is a hormone, blood clotting/coagulation factor, cytokine/growth factor, antibody molecule, fusion protein, protein vaccine, or peptide, these and other exemplary products are shown in Table 2.

TABLE 2

| Therapeutic | | |
|---|---|---|
| Product type | Product | Trade Name |
| Hormone | Erythropoietin, Epoein-α | Epogen, Procrit |
| | Darbepoetin-α | Aranesp |
| | Growth hormone (GH), | Genotropin, Humatrope, |
| | somatotropin | Norditropin, NovIVitropin, |
| | Human follicle-stimulating | Nutropin, Omnitrope, |
| | hormone (FSH) | Protropin, Siazen, |
| | Human chorionic | Serostim, Valtropin |
| | gonadotropin | Gonal-F, Follistim |
| | Lutropin-α | Ovidrel |
| | Glucagon | Luveris |
| | Growth hormone releasing | GlcaGen |
| | hormone (GHRH) | Geref |
| | Secretin | ChiRhoStim (human |
| | Thyroid stimulating | peptide), |
| | hormone (TSH), | SecreFlo |
| | thyrotropin | (porcine peptide) |
| | | Thyrogen |
| Blood | Factor VIIa | NovoSeven |
| Clotting/ | Factor VIII | Bioclate, Helixate, |
| Coagulation | Factor IX | Kogenate, Recombinate, |
| Factors | Antithrombin III (AT-III) | ReFacto |
| | Protein C concentrate | Benefix |
| | | Thrombate III |
| | | Ceprotin |
| Cytokine/ | Type I alpha-interferon | Infergen |
| Growth factor | Interferon-αn3 (IFNαn3) | Alferon N |
| | Interferon-β1a (rIFN-β) | Avonex, Rebif |
| | Interferon-β1b (rIFN-β) | Betaseron |
| | Interferon-γ1b (IFN γ) | Actimmune |
| | Aldesleukin (interleukin | Proleukin |
| | 2(IL2), epidermal | Kepivance |
| | theymocyte activating | Regranex |
| | factor; ETAF | Anril, Kineret |
| | Palifermin (keratinocyte | |
| | growth factor; KGF) | |
| | Becaplemin (platelet- | |
| | derived growth factor; | |
| | PDGF) | |
| | Anakinra (recombinant IL | |
| | 1 antagonist) | |
| Antibody | Bevacizumab (VEGFA | Avastin |
| molecules | mAb) | Erbitux |
| | Cetuximab (EGFR mAb) | Vectibix |
| | Panitumumab (EGFR mAb) | Campath |
| | Alemtuzumab (CD52 mAb) | Rituxan |
| | Rituximab (CD20 chimeric | Herceptin |
| | Ab) | Orencia |
| | Trastuzumab (HER2/Neu | Humira |
| | mAb) | Enbrel |
| | Abatacept (CTLA Ab/Fc | Remicade |
| | fusion) | Amevive |
| | Adalimumab (TNFα mAb) | Raptiva |
| | Etanercept (TNF | Tysabri |
| | receptor/Fc fusion) | Soliris |
| | Infliximab (TNFα chimeric | Orthoclone, OKT3 |
| | mAb) | |
| | Alefacept (CD2 fusion | |
| | protein) | |
| | Efalizumab (CD11a mAb) | |
| | Natalizumab (integrin α4 | |
| | subunit mAb) | |
| | Eculizumab (C5mAb) | |
| | Muromonab-CD3 | |
| Other: | Insulin | Humulin, Novolin |
| Fusion | Hepatitis B surface | Engerix, Recombivax HB |
| proteins/ | antigen (HBsAg) | Gardasil |
| Protein | HPV vaccine | LYMErix |
| vaccines/ | OspA | Rhophylac |
| Peptides | Anti-Rhesus(Rh) | Fuzeon |
| | immunoglobulin G | QMONOS |
| | Enfuvirtide | |
| | Spider silk, e.g., fibrion | |

In embodiments, the protein is multispecific protein, e.g., a bispecific antibody as shown in Table 3.

TABLE 3
Bispecific Formats

| Name (other | | | | | |
|---|---|---|---|---|---|
| names, | | | Proposed | | Diseases (or |
| sponsoring | BsAb | | mechanisms | Development | healthy |
| organizations) | format | Targets | of action | stages | volunteers) |
| Catumaxomab | BsIgG: | CD3, | Retargeting of T | Approved in | Malignant ascites |
| (Removab ®, | Triomab | EpCAM | cells to tumor, Fc | EU | in EpCAM |
| Fresenius Biotech, | | | mediated effector | | positive tumors |
| Trion Pharma, | | | functions | | |
| Neopharm) | | | | | |
| Ertumaxomab | BsIgG: | CD3, HER2 | Retargeting of T | Phase I/II | Advanced solid |
| (Neovii Biotech, | Triomab | | cells to tumor | | tumors |
| Fresenius Biotech) | | | | | |
| Blinatumomab | BiTE | CD3, CD19 | Retargeting of T | Approved in | Precursor B-cell |
| (Blincyto ®, AMG | | | cells to tumor | USA | ALL |
| 103, MT 103, | | | | Phase II and | ALL |
| MEDI 538, | | | | III | DLBCL |
| Amgen) | | | | Phase II | NHL |
| | | | | Phase I | |
| REGN1979 | BsAb | CD3, CD20 | | | |
| (Regeneron) | | | | | |
| Solitomab (AMG | BiTE | CD3, | Retargeting of T | Phase I | Solid tumors |
| 110, MT110, | | EpCAM | cells to tumor | | |
| Amgen) | | | | | |
| MEDI 565 (AMG | BiTE | CD3, CEA | Retargeting of T | Phase I | Gastrointestinal |
| 211, MedImmune, | | | cells to tumor | | adenocancinoma |
| Amgen) | | | | | |
| RO6958688 | BsAb | CD3, CEA | | | |
| (Roche) | | | | | |
| BAY2010112 | BiTE | CD3, PSMA | Retargeting of T | Phase I | Prostate cancer |
| (AMG 212, Bayer; | | | cells to tumor | | |
| Amgen) | | | | | |
| MGD006 | DART | CD3, CD123 | Retargeting of T | Phase I | AML |
| (Macrogenics) | | | cells to tumor | | |
| MGD007 | DART | CD3, gpA33 | Retargeting of T | Phase I | Colorectal cancer |
| (Macrogenics) | | | cells to tumor | | |
| MGD011 | DART | CD19, CD3 | | | |
| (Macrogenics) | | | | | |
| SCORPION | BsAb | CD3, CD19 | Retargeting of T | | |
| (Emergent | | | cells to tumor | | |
| Biosolutions, | | | | | |
| Trubion) | | | | | |
| AFM11 (Affimed | TandAb | CD3, CD19 | Retargeting of T | Phase I | NHL and ALL |
| Therapeutics) | | | cells to tumor | | |
| AFM12 (Affimed | TandAb | CD19, CD16 | Retargeting of NK | | |
| Therapeutics) | | | cells to tumor | | |
| | | | cells | | |
| AFM13 (Affimed | TandAb | CD30, | Retargeting of NK | Phase II | Hodgkin's |
| Therapeutics) | | CD16A | cells to tumor | | Lymphoma |
| | | | cells | | |
| GD2 (Barbara Ann | T cells | CD3, GD2 | Retargeting of T | Phase I/II | Neuroblastoma |
| Karmanos Cancer | preloaded | | cells to tumor | | and |
| Institute) | with BsAb | | | | osteosarcoma |
| pGD2 (Barbara | T cells | CD3, Her2 | Retargeting of T | Phase II | Metastatic breast |
| Ann Karmanos | preloaded | | cells to tumor | | cancer |
| Cancer Institute) | with BsAb | | | | |
| EGFRBi-armed | T cells | CD3, EGFR | Autologous | Phase I | Lung and other |
| autologous | preloaded | | activated T cells | | solid tumors |
| activated T cells | with BsAb | | to EGFR-positive | | |
| (Roger Williams | | | tumor | | |
| Medical Center) | | | | | |
| Anti-EGFR-armed | T cells | CD3, EGFR | Autologous | Phase I | Colon and |
| activated T-cells | preloaded | | activated T cells | | pancreatic |
| (Barbara Ann | with BsAb | | to EGFR-positive | | cancers |
| Karmanos Cancer | | | tumor | | |
| Institute) | | | | | |
| rM28 (University | Tandem | CD28, | Retargeting of T | Phase II | Metastatic |
| Hospital TUML übingen) | scEv | MAPG | cells to tumor | | melanoma |
| IMCgp100 | ImmTAC | CD3, peptide | Retargeting of T | Phase I/II | Metastatic |
| (Immunocore) | | MHC | cells to tumor | | melanoma |
| DT2219ARL | 2 scFv | CD19, CD22 | Targeting of | Phase I | B cell leukemia |
| (NCI, University of | linked to | | protein toxin to | | or lymphoma |
| Minnesota) | diphtheria | | tumor | | |
| | toxin | | | | |
| XmAb5871 | BsAb | CD19, | | | |
| (Xencor) | | CD32b | | | |
| NI-1701 | BsAb | CD47, | | | |
| (NovImmune) | | CD19 | | | |
| MM-111 | BsAb | ErbB2, | | | |
| (Merrimack) | | ErbB3 | | | |
| MM-141 | BsAb | IGF-1R, | | | |
| (Merrimack) | | ErbB3 | | | |
| NA (Merus) | BsAb | HER2, | | | |
| | | HER3 | | | |
| NA (Merus) | BsAb | CD3, | | | |
| | | CLEC12A | | | |
| NA (Merus) | BsAb | EGFR, | | | |
| | | HER3 | | | |
| NA (Merus) | BsAb | PD1, | | | |
| | | undisclosed | | | |
| NA (Merus) | BsAb | CD3, | | | |
| | | undisclosed | | | |
| Duligotuzumab | DAF | EGFR, | Blockade of 2 | Phase I and II | Head and neck |
| (MEHD7945A, | | HER3 | receptors, ADCC | Phase II | cancer |
| Genentech, Roche) | | | | | Colorectal cancer |
| LY3164530 (Eli | Not | EGFR, MET | Blockade of 2 | Phase I | Advanced or |
| Lily) | disclosed | | receptors | | metastatic cancer |
| MM-111 | HSA body | HER2, | Blockade of 2 | Phase II | Gastric and |
| (Merrimack | | HER3 | receptors | Phase I | esophageal |
| Pharmaceuticals) | | | | | cancers |
| | | | | | Breast cancer |
| MM-141, | IgG-scEv | IGF-1R, | Blockade of 2 | Phase I | Advanced solid |
| (Merrimack | | HER3 | receptors | | tumors |
| Pharmaceuticals) | | | | | |
| RG7221 | CrossMab | Ang2, VEGF | Blockade of 2 | Phase I | Solid tumors |
| (RO5520985, | | A | proangiogenics | | |
| Roche) | | | | | |
| RG7716 (Roche) | CrossMab | Ang2, VEGF | Blockade of 2 | Phase I | Wet AMD |
| | | A | proangiogenics | | |
| OMP-305B83 | BsAb | DLL4/VEGF | | | |
| (OncoMed) | | | | | |
| TF2 | Dock and | CEA, HSG | Pretargeting | Phase II | Colorectal, |
| (Immunomedics) | lock | | tumor for PET or | | breast and lung |
| | | | radioimaging | | cancers |
| ABT-981 | DVD-Ig | IL-1α, IL-1β | Blockade of 2 | Phase II | Osteoarthritis |
| (AbbVie) | | | proinflammatory | | |
| | | | cytokines | | |
| ABT-122 | DVD-Ig | TNF, IL-17A | Blockade of 2 | Phase II | Rheumatoid |
| (AbbVie) | | | proinflammatory | | arthritis |
| | | | cytokines | | |
| COVA322 | IgG- | TNF, IL17A | Blockade of 2 | Phase I/II | Plaque psoriasis |
| | fynomer | | proinflammatory | | |
| | | | cytokines | | |
| SAR156597 | Tetravalent | IL-13, IL-4 | Blockade of 2 | Phase I | Idiopathic |
| | bispecific | | proinflammatory | | pulmonary |
| (Sanofi) | tandem IgG | | cytokines | | fibrosis |
| GSK2434735 | Dual- | IL-13, IL-4 | Blockade of 2 | Phase I | (Healthy |
| (GSK) | targeting | | proinflammatory | | volunteers) |
| | domain | | cytokines | | |
| Ozoralizumab | Nanobody | TNF, HSA | Blockade of | Phase II | Rheumatoid |
| (ATN103, Ablynx) | | | proinflammatory | | arthritis |
| | | | cytokine, binds to | | |
| | | | HSA to increase | | |
| | | | half-life | | |
| ALX-0761 (Merck | Nanobody | IL-17A/F, | Blockade of 2 | Phase I | (Healthy |
| Serono, Ablynx) | | HSA | proinflammatory | | volunteers) |
| | | | cytokines, binds | | |
| | | | to HSA to | | |
| | | | increase half-life | | |
| ALX-0061 | Nanobody | IL-6R, HSA | Blockade of | Phase I/II | Rheumatoid |
| (AbbVie, Ablynx; | | | proinflammatory | | arthritis |
| | | | cytokine, binds to | | |
| | | | HSA to increase | | |
| | | | half-life | | |
| ALX-0141 | Nanobody | RANKL, | Blockade of bone | Phase I | Postmenopausal |
| (Ablynx, | | HSA | resorption binds | | bone loss |
| Eddingpharm) | | | to HSA to | | |
| | | | increase half-life | | |
| RG6013/ACE910 | ART-Ig | Factor IXa, | Plasma | Phase II | Hemophilia |
| (Chugai, Roche) | | factor X | coagulation | | |

In embodiments and unless stated otherwise herein, the systems, devices, facilities, and/or methods described herein can also include any suitable unit operation and/or equipment not otherwise mentioned, such as operations and/or equipment for separation, purification, and isolation of such products. Any suitable facility and environment can be used, such as traditional stick-built facilities, modular, mobile and temporary facilities, or any other suitable construction, facility, and/or layout. For example, in some embodiments modular clean-rooms can be used. Additionally and unless otherwise stated, the devices, systems, and methods described herein can be housed and/or performed in a single location or facility or alternatively be housed and/or performed at separate or multiple locations and/or facilities.

Moreover and unless stated otherwise herein, the systems, devices, facilities, and/or methods can include any suitable reactor(s) including but not limited to stirred tank, airlift, fiber, microfiber, hollow fiber, ceramic matrix, fluidized bed, fixed bed, and/or spouted bed bioreactors. As used herein, “reactor” can include a fermentor or fermentation unit, or any other reaction vessel and the term “reactor” is used interchangeably with “fermentor.” For example, in some aspects, an example bioreactor unit can perform one or more, or all, of the following: feeding of nutrients and/or carbon sources, injection of suitable gas (e.g., oxygen), inlet and outlet flow of fermentation or cell culture medium, separation of gas and liquid phases, maintenance of temperature, maintenance of oxygen and CO2 levels, maintenance of pH level, agitation (e.g., stirring), and/or cleaning/sterilizing. Example reactor units, such as a fermentation unit, may contain multiple reactors within the unit, for example the unit can have 1, 2, 3, 4, 5, 10, 15, 20, 25, 30, 35, 40, 45, 50, 60, 70, 80, 90, or 100, or more bioreactors in each unit and/or a facility may contain multiple units having a single or multiple reactors within the facility. In various embodiments, the bioreactor can be suitable for batch, semi fed-batch, fed-batch, perfusion, and/or a continuous fermentation processes. Any suitable reactor diameter can be used. In embodiments, the bioreactor can have a volume between about 100 mL and about 50,000 L. Non-limiting examples include a volume of 100 mL, 250 mL, 500 mL, 750 mL, 1 liter, 2 liters, 3 liters, 4 liters, 5 liters, 6 liters, 7 liters, 8 liters, 9 liters, 10 liters, 15 liters, 20 liters, 25 liters, 30 liters, 40 liters, 50 liters, 60 liters, 70 liters, 80 liters, 90 liters, 100 liters, 150 liters, 200 liters, 250 liters, 300 liters, 350 liters, 400 liters, 450 liters, 500 liters, 550 liters, 600 liters, 650 liters, 700 liters, 750 liters, 800 liters, 850 liters, 900 liters, 950 liters, 1000 liters, 1500 liters, 2000 liters, 2500 liters, 3000 liters, 3500 liters, 4000 liters, 4500 liters, 5000 liters, 6000 liters, 7000 liters, 8000 liters, 9000 liters, 10,000 liters, 15,000 liters, 20,000 liters, and/or 50,000 liters. Additionally, suitable reactors can be multi-use, single-use, disposable, or non-disposable and can be formed of any suitable material including metal alloys such as stainless steel (e.g., 316 L or any other suitable stainless steel) and Inconel, plastics, and/or glass.

Unless stated otherwise herein, the systems, devices, facilities, and/or methods can include any desired volume or production capacity including but not limited to bench-scale, pilot-scale, and full production scale capacities.

By way of non-limiting examples and without limitation, U.S. Patent Publication Nos. 2012/0077429; 2011/0312087; 2009/0305626; and U.S. Pat. Nos. 9,388,373; 8,771,635; 8,298,054; 7,629,167; and 5,656,491, which are hereby incorporated by reference in their entirety, describe example facilities, equipment, and/or systems that may be suitable.

The embodiments, aspects, and/or examples described in the disclosure are advantageous in various ways. For example, tagging all of the parameters of interest when a particular recipe is built allows for the tagged parameters to be “pushed” to a messaging queue, one or more separate databases designated for such data, and/or middleware, rather than a user and/or operator “pulling” the parameters from various storage devices scattered across the system database. In at least that regard, the information is easily, conveniently, and quickly accessible from any geographical location at any time in real-time (and not at a later time). Moreover, information is pushed out with various contextual data, metadata, such as external analytics system information and other types of contextual data, allowing the information to be in more relatable form and also allowing user and/or operator to better perform analysis on the information, such as, selecting and analyzing the data presented to the user. In addition, the extracted information may reside in local memory of the computing device executing the recipe, which makes it unnecessary to perform database calls.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof. Although the disclosure uses terminology and acronyms that may not be familiar to the layperson, those skilled in the art will be familiar with the terminology and acronyms used herein.

What is claimed is:

1. A system for automated batch data analysis for pharmaceutical production, the system comprising:
at least one system component;
a database;
at least one computing device for executing stored programmable instructions to:
acquire data associated with the at least one system component;
determine which data from the received data are identified for extraction based at least in part on a tag, and
extract the tagged data based on the determination.

2. The system of claim 1, wherein the at least one computing device is further configured to execute a recipe using the at least one system component.

3. The system of claim 1, wherein the at least one computing device is further configured to output the extracted data to one or more of: (i) the database, (ii) local memory of the at least one computing device, and (iii) a messaging queue.

4. The system of claim 3, wherein analysis is performed on the data.

5. The system of claim 4, wherein the database includes one or more storage devices separately designated to store the extracted data.

6. The system of claim 1, wherein the at least one system component is: (i) a bioreactor, (ii) fermentation equipment, (iii) harvest equipment, (iv) microfiltration and purification equipment, (v) media preparation equipment, or (vi) buffer preparation equipment.

7. The system of claim 1, further including one or more of: (i) a sensor, (ii) a transmitter, (iii) a scale, (iv) a switch, (v) a pump, (vi) a pump, (vii) a control valve, (viii) a discrete valve, (ix) a pump with a fixed-speed starter, (x) a pump with a variable frequency drive, (xi) an agitator, (xii) an agitator with a variable frequency drive, and (xiii) a discrete value with a limit switch.

8. The system of claim 7, wherein the data is acquired from one or more of: (i) the sensor, (ii) the transmitter, (iii) the scale, (iv) the switch, (v) the pump, (vi) the pump, (vii) the control valve, (viii) the discrete valve, (ix) the pump with the fixed-speed starter, (x) the pump with the variable frequency drive, (xi) the agitator, (xii) the agitator with the variable frequency drive, and (xiii) the discrete value with the limit switch.

9. The system of claim 2, wherein the recipe is a set of instructions for performing a task associated with the at least one system component.

10. The system of claim 9, wherein the set of instructions are configured by an operator.

11. The system of claim 9, wherein the tag identifies one or more of: (i) parameters and (ii) metadata in the acquired data, of interest, for further analysis.

12. The system of claim 11, wherein the tag is implementable for each instruction in the set of instructions such that the one or more parameters of interest are identified and extracted during execution of the respective instruction.

13. The system of claim 1, wherein the acquired data is batch data.

14. The system of claim 1, wherein the data is manually entered into the system by an operator.

15. The system of claim 11, wherein the one or more of the parameters and the metadata are selectable by the user.

16. The system of claim 1, wherein the data is automatically summarized in a particular format.

17. The system of claim 1, wherein the at least one system component is a chemical reactor.

18. A method for automated batch data analysis for pharmaceutical production, the method comprising:
acquiring, by at least one computing device, data associated with a component of a system;
determining, by the at least one computing device, which data from the received data are identified for extraction based at least in part on a tag; and
extracting, by the at least one computing device, the tagged data based on the determination.

19. A non-transitory computer readable medium storing programmable instructions, the programmable instructions when executed by at least one computing device causes the at least one computing device to perform a method for automated batch data analysis for pharmaceutical production, the method comprising:
acquiring data associated with at least one component of a system;
determining which data from the received data are identified for extraction based at least in part on a tag; and
extracting the tagged data based on the determination.

20. A computing device for automated batch data analysis for pharmaceutical production, the computing device comprising:
memory;
at least one processor for executing stored instructions to:
acquire data associated with at least one system component;
determine which data from the received data are identified for extraction based at least in part on a tag, and
extract the tagged data based on the determination.
